(19) United States
(12) Patent Application Publication
(10) Pub. No.: US 2026/0218839 A1
(43) Pub. Date: Jul. 30, 2026

(54) MOUNTING ASSEMBLY AND CONNECTOR

(71) Applicant: BOMBARDIER RECREATIONAL PRODUCTS INC., Valcourt (CA)

(72) Inventor: Abdelkarim MESKINE, Valcourt (CA)

(21) Appl. No.: 19/454,501

(22) Filed: Jan. 21, 2026

Related U.S. Application Data
(60) Provisional application No. 63/751,332, filed on Jan. 30, 2025.

(51) Int. Cl. F16M 11/04; F16M 11/08; F16M 13/02

(52) U.S. Cl. CPC F16M 11/041; F16M 11/08; F16M 13/02

(57) ABSTRACT

A mounting assembly includes a mounting base defining an aperture and a connector. The connector includes a base, an anchor, a locking member movable between unlocked and locked positions and a biasing member biasing the locking member toward the locked position. The connector is movable relative to the mounting base between a released position, in which the anchor is aligned with the aperture, and the locking member is misaligned with the aperture, and an anchored position, in which the anchor is received in and misaligned with the aperture, and the locking member is aligned with the aperture, and is movable between the unlocked position, in which the locking member is removed from the aperture, and the anchor is movable to the released position, and a locked position, in which the locking member is at least partially received in the aperture, thereby preventing movement of the connector to the released position.

### CROSS-REFERENCE TO RELATED APPLICATION

The present application claims priority to United States Provisional Ser. No. 63/751,332 , filed Jan. 30, 2025, entitled “Mounting Assembly and Connector”, which is incorporated by reference herein in its entirety.

### FIELD OF THE TECHNOLOGY

The present technology relates to mounting assemblies and connectors.

### BACKGROUND

Mounting assemblies are often provided to connect accessories such as personal items or tools to various structures such as a body panel of a vehicle. Some conventional mounting assemblies include a mounting base that can connect to the structure, and a connector that can connect to the accessory and to the mounting base.

In conventional mounting assemblies, the connector can easily and/or accidentally become disconnected from the mounting base while handling the accessory. In some other conventional mounting assemblies, disconnection of the connector from the mounting base can be a long and tedious process.

Therefore, there is a desire for a technology that mitigates these limitations and addresses at least some of the aforementioned drawbacks.

### SUMMARY

It is an object of the present invention to ameliorate at least some of the inconveniences present in the prior art.

According to an aspect of the present technology, there is provided a mounting assembly including a mounting base and a connector. The mounting base defines an aperture. The connector is selectively connected to the mounting base. The connector includes a base, an anchor, a locking member, and a biasing member. The base is larger than the aperture. The anchor is connected to the base, and is configured to be received in the aperture. The locking member is movably connected to the base, and is movable between an unlocked position and a locked position. The biasing member abuts the locking member, and biases the locking member toward the locked position. The connector is movable relative to the mounting base between a released position and an anchored position. In the released position, the anchor is aligned with the aperture such that the anchor is free to pass through the aperture, and the locking member is misaligned with the aperture. In the anchored position, the anchor is received in and misaligned with the aperture such that the anchor is prevented from passing through the aperture. The locking member is aligned with the aperture, and is movable between the unlocked and locked positions. In the unlocked position, the locking member is removed from the aperture, and the anchor is movable to the released position. In the locked position, the locking member is at least partially received in the aperture, and the locking member thereby prevents movement of the connector to the released position.

In some embodiments, with the connector in the released position, and with the anchor received through the aperture, the locking member abuts the mounting base, the mounting base preventing the locking member from reaching the locked position.

In some embodiments, the mounting assembly further includes a connecting portion connected to the base, the connecting portion being configured to connect to an accessory.

In some embodiments, the mounting assembly further includes the accessory connected to the connecting portion.

In some embodiments, the locking member translates between the unlocked position and the locked position.

In some embodiments, the connector rotates about a rotation axis between the released position and the anchored position.

In some embodiments, the mounting assembly further includes a connecting portion connected to the base, the connecting portion being configured to connect to an accessory, the connecting portion being rotatable relative to the base about the rotation axis.

In some embodiments, the locking member translates between the unlocked position and the locked position along a translation axis, the translation axis being substantially parallel to the rotation axis.

In some embodiments, the aperture has a first elongate shape, and the anchor has a second elongate shape, the second elongate shape being similar to the first elongate shape, the second elongate shape having smaller dimensions than the first elongate shape.

In some embodiments, the anchor has a first cam and a second cam extending opposite to the first cam, the first cam and the second cam defining the second elongate shape.

In some embodiments, the base further comprises at least one stopper configured to stop movement of the connector once the anchored position is reached.

In some embodiments, the locking member is radially and angularly offset from the anchor.

In some embodiments, the locking member is angularly offset from the anchor by about 90 degrees.

In some embodiments, the anchor and the base are monolithic.

In some embodiments, the biasing member is a spring disposed between the base and the locking member.

In some embodiments, the locking member has an engaging tab extending beyond a lateral side of the base.

In some embodiments, the base defines a locking recess, the recess having an at least partially open bottom, and the locking member is at least partially received in the locking recess. With the locking member in the locked position, at least part of the locking member extends out of the at least partially open bottom. With the locking member in the unlocked position, the locking member is at least mostly received in the recess.

In some embodiments, with the locking member in the unlocked position, a bottom of the locking member is disposed in the locking recess.

According to another aspect of the present technology, there is provided a connector including a base, a stem, an anchor, a locking member and a biasing member. The stem is connected to the base, and defines a rotation axis. The anchor is connected to the base via the stem. The locking member is movably connected to the base, and translates between an unlocked position and a locked position along a translation axis. The translation axis is parallel to the rotation axis. The biasing member abuts the locking member, and biases the locking member toward the locked position. The base defines a first end of the connector. The locking member defines a second end of the connector, the second end being opposite the first end. The locking member translates away from the first end as the locking member translates from the unlocked position to the locked position. The locking member translates toward the first end as the locking member translates from the locked position to the unlocked position.

In some embodiments, the connector further includes a connecting portion connected to the base, the connecting portion being configured to connect to an accessory.

In some embodiments, the connecting portion is rotatable relative to the base about the rotation axis.

In some embodiments, the anchor has a first cam and a second cam extending opposite to the first cam, the first cam and the second cam defining an elongate shape.

In some embodiments, the locking member is radially and angularly offset from the anchor.

In some embodiments, the locking member is angularly offset from the anchor by about 90 degrees.

In some embodiments, the locking member has an engaging tab extending beyond a lateral side of the base.

In some embodiments, the base defines a locking recess, the recess having an at least partially open bottom, and the locking member is at least partially received in the locking recess. With the locking member in the locked position, at least part of the locking member extends out of the at least partially open bottom. With the locking member in the unlocked position, the locking member is at least mostly received in the recess.

In some embodiments, with the locking member in the unlocked position, a bottom of the locking member is disposed in the locking recess.

For purposes of the present application, the accessory could be implemented as a variety of objects. The accessory could be one or more of, but is not limited to, storage containers, bags, pouches, nets, speakers, lights or illumination devices, communication devices (for example, walkie-talkies), toolkits, fishing pouch/tools, hunting tools, winch remotes, quick detaches for vehicle body panels, helmets, helmet accessories, cameras, phones, food containers, and water bottles.

For purposes of the present application, terms related to spatial orientation when referring to a watercraft, such as “vertical”, “horizontal”, “forwardly”, “rearwardly”, “left”, “right”, “above” and “below”, are as they would be understood by a driver of the watercraft sitting thereon in an upright driving position, with the watercraft steered straight-ahead in a neutral trim position and being at rest in calm water. When referring to a component alone, terms related to spatial orientation should be taken with respect to the component itself.

Embodiments of the present invention each have at least one of the above-mentioned objects and/or aspects, but do not necessarily have all of them. It should be understood that some aspects of the present invention that have resulted from attempting to attain the above-mentioned object may not satisfy this object and/or may satisfy other objects not specifically recited herein.

Additional and/or alternative features, aspects, and advantages of embodiments of the present invention will become apparent from the following description and the accompanying drawings.

### BRIEF DESCRIPTION OF THE DRAWINGS

For a better understanding of the present invention, as well as other aspects and further features thereof, reference is made to the following description, which is to be used in conjunction with the accompanying drawings, where:

FIG. 1 is a perspective view taken from a top, front, left side of a personal watercraft having a mounting assembly according to an embodiment of the present technology;

FIG. 2 is an exploded perspective view taken from a top, front, right side of the mounting assembly of FIG. 1;

FIG. 3 is an exploded perspective view taken from a top, rear, left side of the mounting assembly of FIG. 1;

FIG. 4 is a perspective view taken from a top, front, right side of a mounting base of the mounting assembly of FIG. 1, with a connector of the mounting assembly being in an anchored position relative to the mounting base, and a locking member of the connector being in a locked position;

FIG. 5 is a perspective view taken from a bottom, front, left side of the mounting base and the connector of FIG. 4;

FIG. 6 is a top plan view of the mounting base and the connector of FIG. 5;

FIG. 7 is a cross-sectional view of the mounting base and the connector of FIG. 5 taken along the line 7-7 of FIG. 6;

FIG. 8 is a perspective view taken from a top, front, left side of the mounting base of FIG. 4, with the connector being in a released position relative to the mounting base, and the locking member being in an unlocked position;

FIG. 9 is a perspective view taken from a bottom, rear, left side of the mounting base and the connector of FIG. 8;

FIG. 10 is a top plan view of the mounting base and the connector of FIG. 8;

FIG. 11 is a cross-sectional view of the mounting base and the connector of FIG. 8 taken along the line 11-11 of FIG. 10; and

FIG. 12 is a perspective view taken from a bottom, front, left side of the connector of FIG. 4.

### DETAILED DESCRIPTION

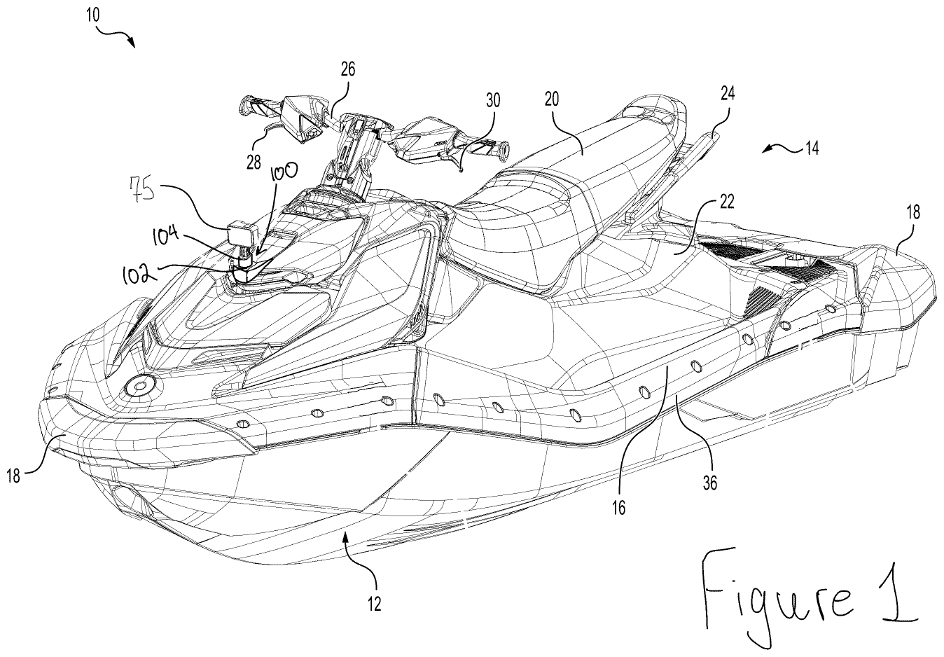

The present technology relates to a mounting assembly 100 that is configured to connect an accessory 75 to an item. In the illustrated embodiment, the item is part of a personal watercraft, such that the mounting assembly 100 will be described with reference to a personal watercraft 10 (shown in FIG. 1). It is contemplated that the personal watercraft 10 could be any other suitable vehicle. It is further contemplated that the item could be a soft item, such as a textile-based item. For example, the item 10 could be a garment such as a life-jacket.

FIG. 1 illustrates the personal watercraft 10. The personal watercraft 10 has a watercraft body made of two main parts. These parts are the hull 12 and the deck 14, which is disposed on the hull 12. The hull 12 buoyantly supports the watercraft 10 in the water. The deck 14 is designed to accommodate a driver and two passengers. It is contemplated that in alternative embodiments, the deck 14 could accommodate only the driver, the driver and one passenger, or the driver and more than two passengers. The hull 12 and deck 14 are joined together by fasteners, more particularly screws. Adhesive and other types of fasteners, such as bolts or rivets, may also be used to join the hull 12 to the deck 14. The portions of the watercraft 10 where the hull 12 and the deck 14 are joined form an outwardly extending flange 16. Bumpers 18 cover the front and rear portions of the flange 16. The volume created between the hull 12 and the deck 14 is known as the motor compartment. The motor compartment accommodates the engine (not shown) as well as the muffler, exhaust pipe, gas tank, electrical system (battery, electronic control unit, etc.), air box, storage bins and other elements required by or desired for the watercraft 10. In an alternative embodiment, the motor compartment may alternatively accommodate an electric motor, batteries, and associated components instead of the previously mentioned components should the watercraft 10 be an electric personal watercraft.

The deck 14 has a centrally positioned straddle-type seat 20 placed on top of a pedestal 22 to accommodate a rider in a straddling position. A grab handle 24 is provided between the pedestal 22 and the straddle-type seat 20 at the rear of the straddle-type seat 20 to provide a handle onto which a passenger may hold. The seat 20 is removably attached to the pedestal 22 by a hook and tongue assembly (not shown) at the front of the seat 20 and by a latch assembly (not shown) at the rear of the seat 20, or by any other known attachment mechanism. The seat 20 covers a motor access opening (not shown), defined by a top portion of the pedestal 22, which provides access to the engine (not shown).

The engine drives a jet propulsion unit (not shown) for propelling the watercraft 10. The jet propulsion unit includes a steering nozzle (not shown) for redirecting a jet of water expelled from the jet propulsion unit. The steering nozzle is operatively connected to a handlebar 26 provided forward of the seat 20. A throttle lever 28 provided on a right side of the handlebar 26 controls an operation of the engine, and thereby a speed of the watercraft 10. A reverse lever 30 provided on a left side of the handlebar 26 controls an operation of a reverse gate (not shown) operatively connected to the jet propulsion unit for reversing a direction of travel of the watercraft 10. In some embodiments, in addition to controlling operation of the reverse gate, the reverse lever 30 simultaneously controls operation of the engine in order to brake and reverse the watercraft 10.

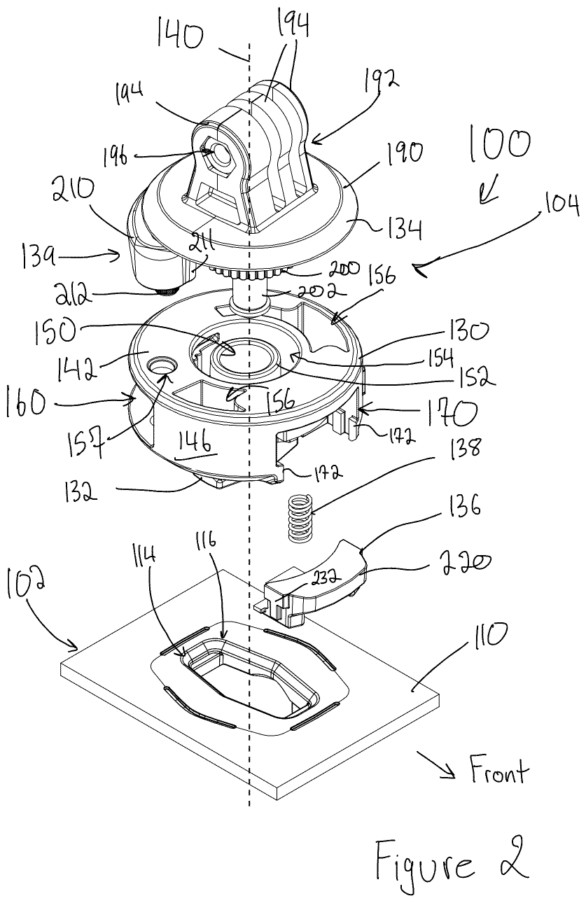

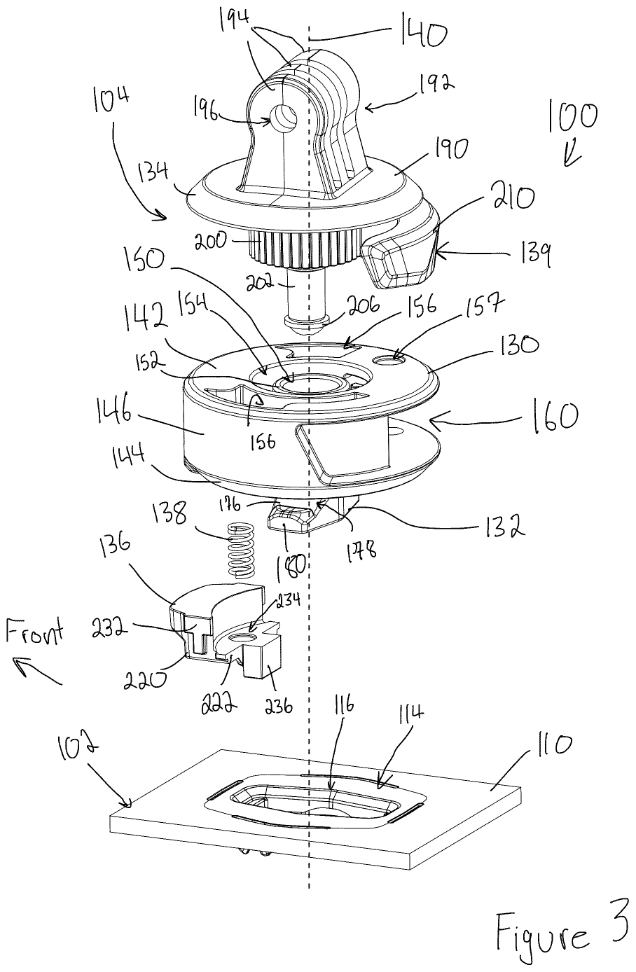

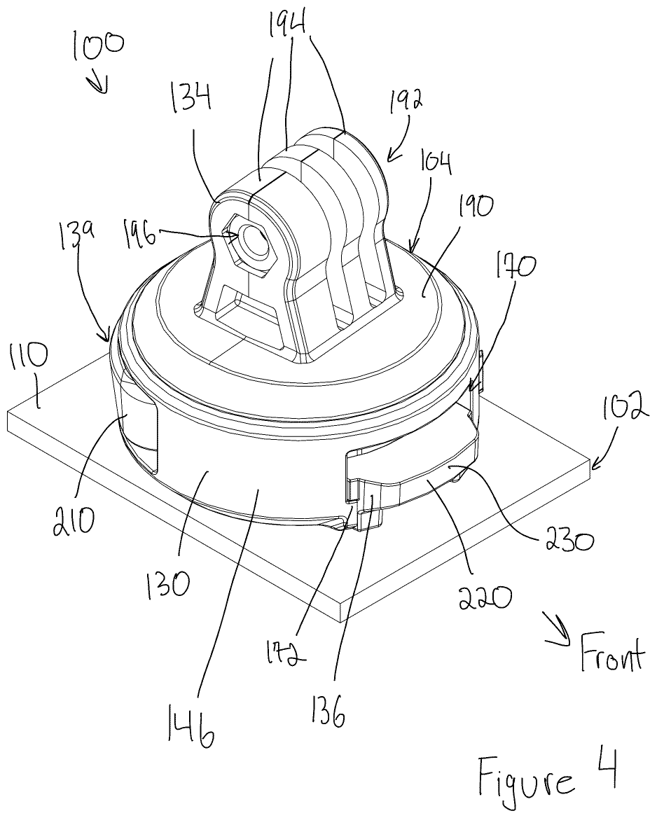

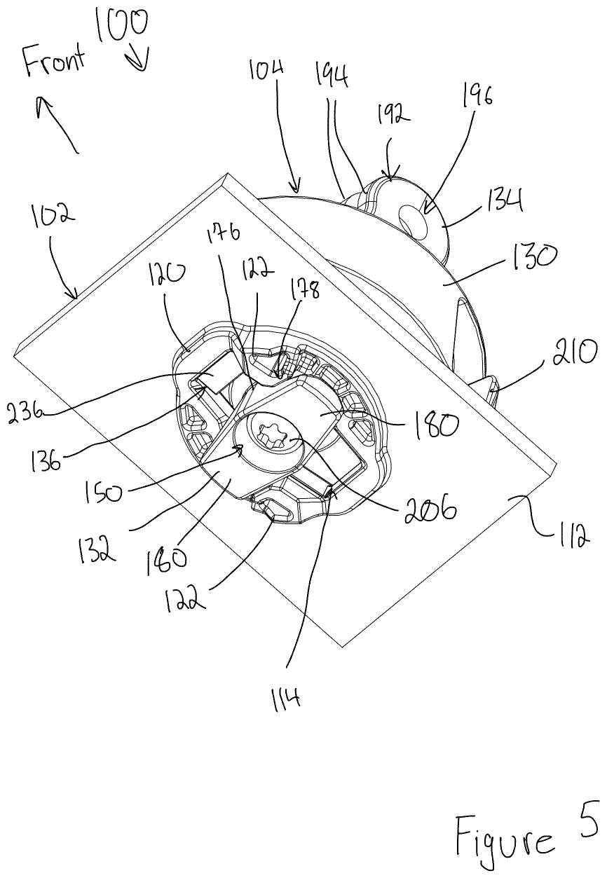

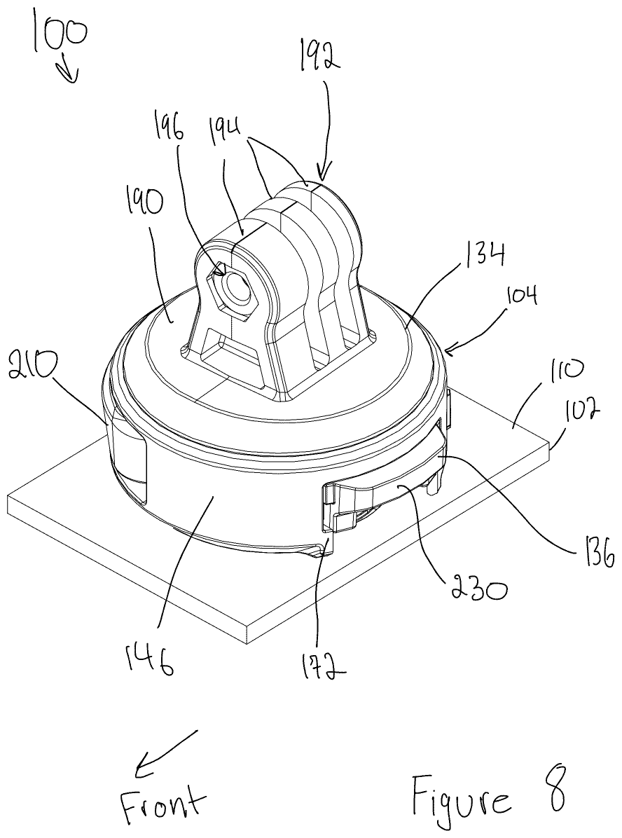

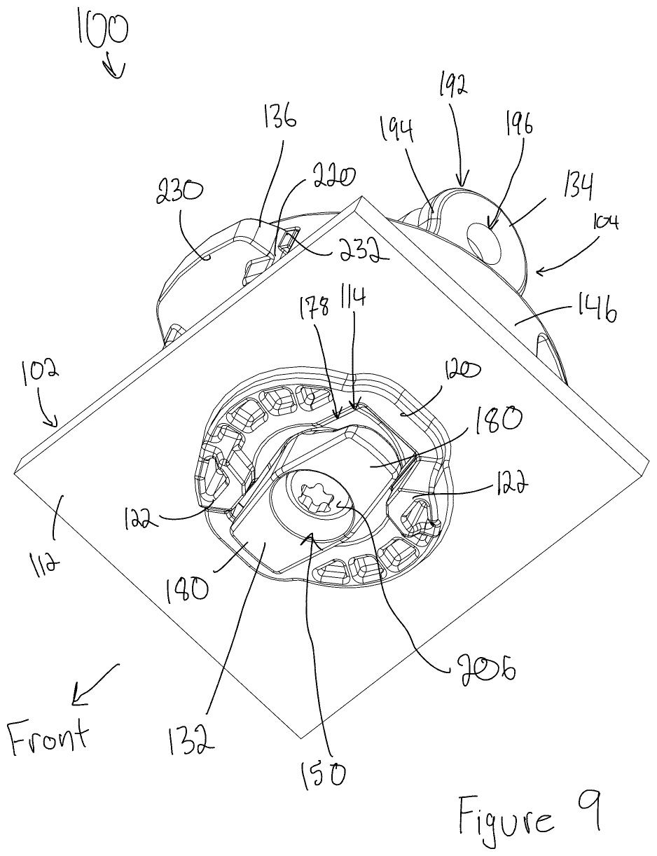

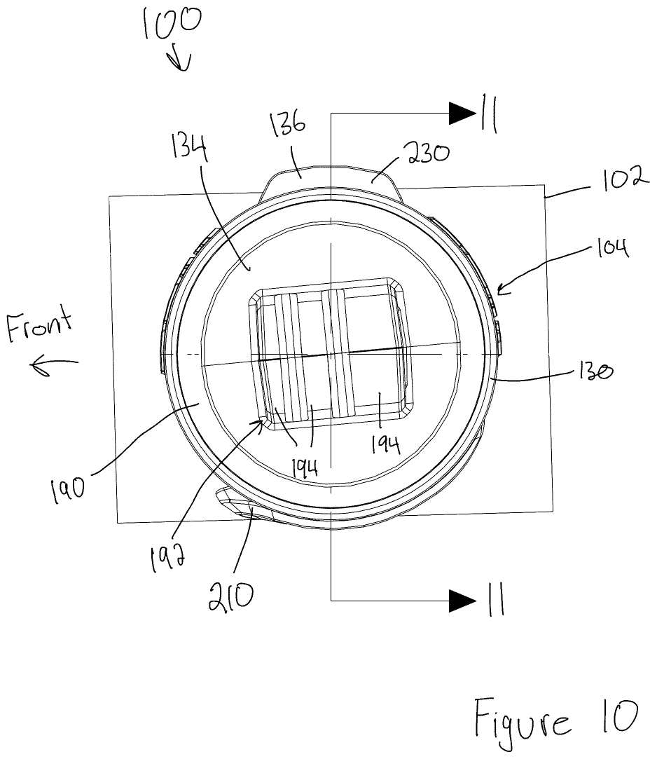

Referring to FIGS. 2 and 3, the mounting assembly 100 includes a mounting base 102 and a connector 104. As will be described in greater detail below, the connector 104 is movable, relative to the mounting base 102, between an anchored position (FIGS. 4 to 7), in which the connector 104 is anchored to the mounting base 102, and a released position (FIGS. 8 to 11), in which the connector 104 can be released from the mounting base 102.

The mounting base 102 is connected to a generally flat and horizontal portion of the deck 14. The mounting base 102 is disposed forward of the handlebar 26, at a lateral center of the watercraft 10. It is contemplated that the mounting base 102 could be connected to any suitable part of the personal watercraft 10 such as, for example, to the pedestal 22. It is also contemplated that the mounting base 102 could be integral with a fairing forming the deck 14.

Referring to FIGS. 2 to 5, the mounting base 102 has an upper side 110 and a lower side 112. The mounting base 102 defines an elongate aperture 114. The elongate aperture 114 defines a hexagonal shape. It is contemplated that in other embodiments, the elongate aperture 114 could define another shape, such as, for example, a rectangular shape or an octagonal shape. The elongate aperture 114 has, on the upper side 110 of the mounting base 102, a tapered section 116. The elongate aperture 114 is therefore similar to a countersink aperture. In some embodiments, the tapered section 116 may be omitted.

On the lower side 112, the mounting base 102 has a lower projection 120 surrounding the elongate aperture 114. The lower projection 120 extends away from the lower side 112, and forms two stoppers 122 disposed opposite to one another (i.e., generally disposed 180 degrees from one another). It is contemplated that in some embodiments, the lower projection 120 could be omitted, such that the stoppers 122 would extend directly from the lower side 112 of the mounting base 102. It is also contemplated that there could only be a single stopper 122. It is further contemplated that the stoppers 122 could be omitted altogether. As will be described below, the stoppers 122 are configured to engage the connector 104 for limiting rotational movement thereof relative to the mounting base 102.

Referring to FIGS. 2 to 11, the connector 104 includes a base 130, an anchor 132, a connecting portion 134, a locking member 136, a biasing member 138 and a fixing assembly 139. It is contemplated that the connector 104 could have fewer or additional components. For example, in some embodiments, the connecting portion 134 and/or the fixing assembly 139 could be omitted. As will be described below, with the mounting base 102 in the anchored position, the locking member 136 is movable between a locked position (FIGS. 4 to 7 and 12) and an unlocked position (FIGS. 8 to 11). When the locking member 136 is in the locked position, the locking member 136 prevents movement of the connector 104 relative to the mounting base 102.

The base 130 has a generally cylindrical shape. It is contemplated that the base 130 could be shaped differently. For example, the base 130 could have a cuboidal shape. The base 130 extends parallel to a center axis 140 that is defined by the anchor 132. In the present embodiment, the center axis 140 extends generally vertically, and the base 130 is symmetric about the center axis 140. It is contemplated that in other embodiments, the base 130 could be asymmetric about the center axis 140. The base 130 further has an upper wall 142, a lower wall 144 and a lateral wall 146. The upper and lower walls 142, 144 extend generally radially from the center axis 140. The lateral wall 146 extends between the upper and lower walls 142, 144, generally parallel to the center axis 140. The base 130, more specifically the lower wall 144, is larger than the elongate aperture 114.

The base 130 defines a center aperture 150 (FIGS. 3, 7 and 9) extending axially along the center axis 140. The center aperture 150 extends through the base 130, such that the center aperture 150 is a through aperture. The center aperture 150 is configured to receive part of the connecting portion 134 therein.

The center aperture 150 is defined in part by a cylindrical rib 152. The cylindrical rib 152 extends from the lower wall 144 toward the upper wall 142. Radially outwardly from the cylindrical rib 152, the base 130 defines an annular recess 154. The annular recess 154 extends from the upper wall 142 toward the lower wall 144. As will be described in greater detail below, the annular recess 154 is configured to receive part of the connecting portion 134 therein.

The base 130 further defines two upper apertures 156 and an upper aperture 157 (FIG. 2) extending from the upper wall 142 toward the lower wall 144. The upper apertures 156, 157 are configured to receive components of the connecting portion 134 and the fixing assembly 139 therein.

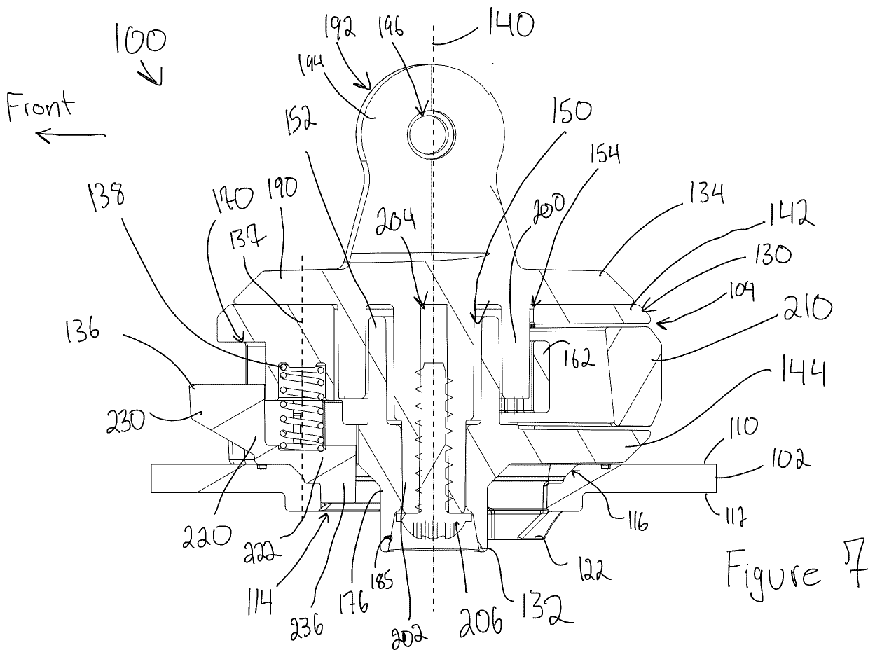

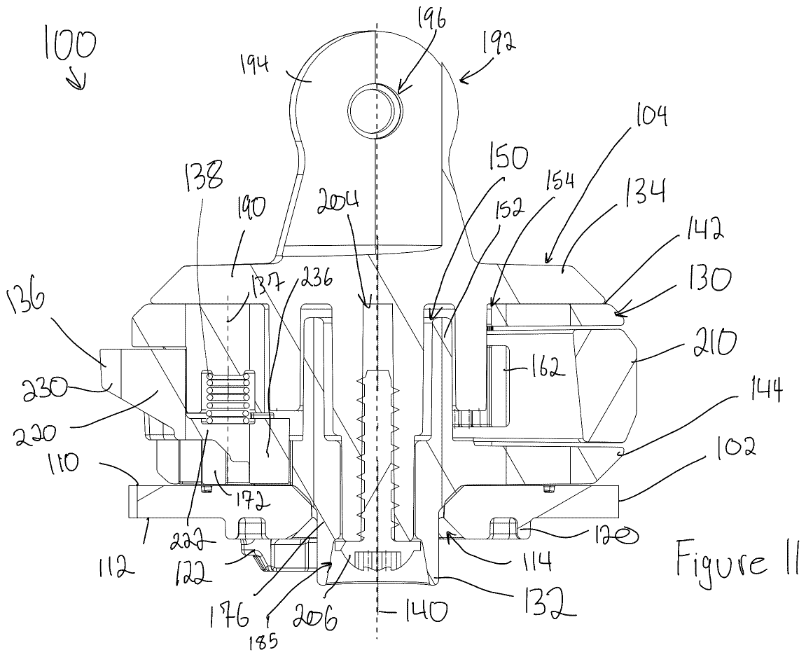

The base 130 further defines, on the lateral wall 146, a side recess 160. The side recess 160 extends radially such that it reaches the annular recess 154. A fixing member 162 (shown in FIGS. 7 and 11) extends within the side recess 160, proximate to the annular recess 154. The fixing member 162 has a toothed configuration. The fixing member 162 is part of the fixing assembly 139, and is connected to the base 130. In some embodiments, the fixing member 162 could be part of the base 130. As will be described below, the fixing member 162 is configured to fix a position of the connecting portion 134 relative to the base 130.

The base 130 further defines, also on the lateral wall 146, a locking recess 170 configured to receive the locking member 136. The locking recess 170 is angularly offset from the side recess 160. The locking recess 170 extends axially parallel to the center axis 140. The locking recess 170 is disposed such that a bottom thereof is open. The locking recess 170 is sized to receive the locking member 136 as the locking member 136 moves between the locked and unlocked positions.

The base 130 further has an interlocker 172 disposed on either lateral side of the locking recess 170. More specifically, the interlockers 172 extend circumferentially into the locking recess 170. As will be described below, the interlockers 172 are configured to interlock with the locking member 136 for limiting radial movement of the locking member 136 relative to the base 130.

The base 130 also has a stem 176 extending downwardly from the lower wall 146. The stem 176 is aligned with the center axis 140, such that the center aperture 150 extends through the stem 176 also. Additionally, the stem 176 is sized to fit within the elongate aperture 114 regardless of the rotational position of the connector 104 relative to the mounting base 102.

The anchor 132 is connected to the base 130 via the stem 176. The stem 176 provides a gap 178 between the lower wall 146 and the anchor 132. The gap 178 is configured to accommodate the thickness of the mounting base 102 at the location of the lower projection 120.

The anchor 132 is disposed such that a center of the anchor 132 is aligned with the center axis 140. Thus, the center aperture 150 extends through the anchor 132 also.

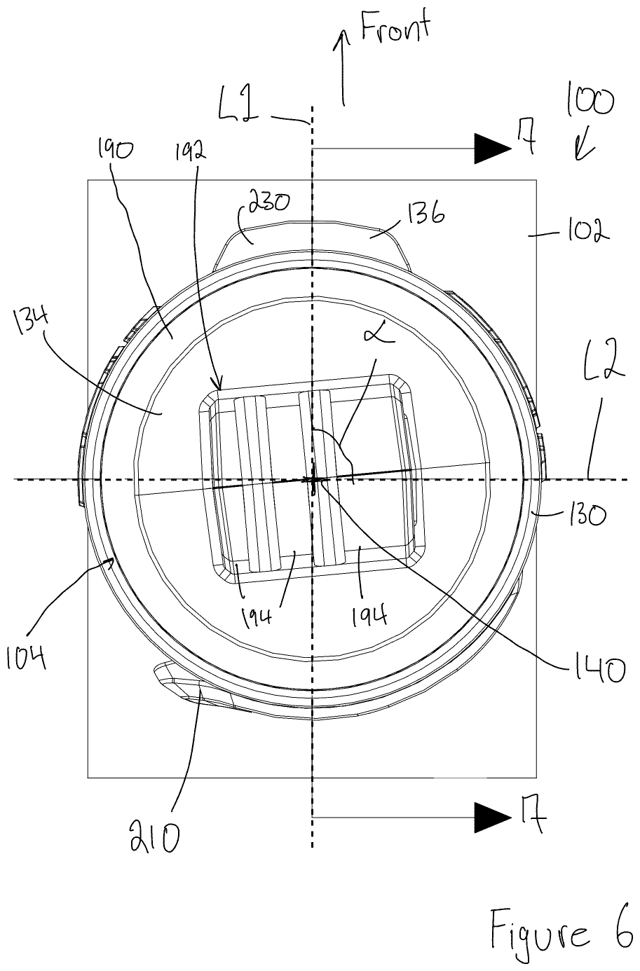

The anchor 132 has two cams 180 extending from opposite sides of the stem 176 in opposite directions from each other. The cams 180 extend substantially perpendicularly to the center axis 140. The orientation of the cams 180, and thus, the orientation of the anchor 132, is such that the cams 180 are angularly offset from the locking recess 170. That is, referring to FIG. 6, a line L1 passing through the center axis 140 and a center of the locking recess 170 is at an angle α to a line L2 that extends through the center axis 140 and the center of the cams 180. In the present embodiment, the angle α is about 90 degrees. It is contemplated that in other embodiments, the angle α could be different. For example, the angle α could be about 30 degrees or about 45 degrees.

The cams 180 are configured such that the anchor 132 defines the same shape as the elongate aperture 114. Thus, the cams 180 define a hexagonal shape that has smaller dimensions than the elongate aperture 114, such that the anchor 132 can be inserted into the elongate aperture 114. More specifically, as will be described below, due to the elongate shape of the elongate aperture 114 and the anchor 132, the anchor 132 can be inserted into the elongate aperture 114 and pulled out therefrom when the cams 180 are correctly aligned with the elongate aperture 114 (i.e., when the connector 104 is in specific positions with respect to the mounting base 102).

It is contemplated, however, that in other embodiments, the anchor 132 could have a shape different from the shape of the elongate aperture 114. For example, the elongate aperture 114 may define a hexagonal shape, whereas the anchor 132 may have a trapezoidal shape sized to fit in the elongate aperture 114.

In the present embodiment, the base 130, the stem 176 and the anchor 132 are monolithic, such that the base 130, the stem 176 and the anchor 132 are formed as a unit and therefore move together. Therefore, when the base 130 is rotated about the center axis 140, the stem 176 and the anchor 132 also rotate about the center axis 140. It is contemplated that in other embodiments, the base 130, the stem 176 and/or the anchor 132 could be distinct pieces connected to one another.

Referring to FIGS. 2 to 4 and 7, the connecting portion 134 will now be described in greater detail. The connecting portion 134 is configured to connect the accessory 75 (shown in FIG. 1) to the connector 104. Thus, when the accessory 75 is connected to the connector 104, and the connector 104 is connected to the mounting base 102, the accessory 75 is connected to the mounting base 102.

The connecting portion 134 has a connecting base 190, an accessory mount 192 extending upwardly from the connecting base 190, a cylindrical rib 200 (FIGS. 3 and 7) extending downwardly from the connecting base 190, and a connecting segment 202 (FIG. 7) also extending downwardly from the connecting base 190. It is contemplated that the configuration of the connecting portion 134 could vary. For example, in some embodiments, the accessory mount 192 could be omitted. In such an embodiment, the accessory 75 could be fastened, bonded, integrally formed with, or otherwise connected directly to the connecting base 190.

The connecting base 190 is configured to sit on the upper wall 144 of the base 130. The connecting base 190 is sized and shaped similarly to the upper wall 144 of the base 130. Thus, with the connecting base 190 disposed on the upper wall 144, the connecting base 190 extends over the upper apertures 156.

The accessory mount 192 is configured to connect to a body of the accessory 75. In the present embodiment, the accessory mount 192 includes three stands 194 projecting upward from a top surface of the connecting base 190. Each of the stands 194 defines an opening 196. The openings 196 are aligned with one another and are configured to receive a fastener (not shown) that engages the accessory 75. More specifically, the accessory 75 has two stands (not shown) defining respective openings and received between the stands 194. The fastener is inserted through the stands 194 and through the stands of the accessory 75. As a result, the accessory 75 can be made to pivot or not about the fastener by adjusting the tightness with which the fastener is secured (the tighter the fastening of the fastener, the greater the resistance to pivoting of the accessory 75 about the fastener). The accessory mount 192 may be configured differently in other embodiments.

As best seen in FIG. 7, the cylindrical rib 200 is sized and shaped such that when the connecting base 190 is seated on the upper wall 146, the cylindrical rib 200 is received in the annular recess 154. A radially outer surface of the cylindrical rib 200 is toothed (best seen in FIG. 3). As will be described below, the cylindrical rib 200 is configured to engage with the fixing member 162 for fixing a position of the connecting portion 134 relative to the base 130.

With continued reference to FIG. 7, the connecting segment 202 is disposed at a center of the connecting portion 134, such that the connecting segment 202 is disposed within the cylindrical rib 200. The connecting segment 202 is sized to extend downwardly beyond the cylindrical rib 200. More specifically, the connecting segment 202 is sized and shaped to be received in the center aperture 150 of the base 130. The connecting segment 202 defines a threaded aperture 204 that receives a fastener 206, which connects the connecting portion 134 to the base 130.

Thus, the accessory base 190 sits on the upper wall 144, the cylindrical rib 200 of the connecting portion 134 is received in the annular recess 154, and the connecting segment 202 is received in the center aperture 150. Thus, the cylindrical rib 152 of the base 130 is disposed radially between the cylindrical rib 200 and the connecting segment 202. Additionally, the fastener 206 is received through the center aperture 150, from the side of the anchor 132, and is fastened to the connecting segment 202 via the threaded aperture 204. A head of the fastener 206 is received in a recess 185 (FIGS. 7 and 11) defined in the anchor 132, abuts against part of the base 130, and prevents movement of the connecting portion 134 away from the base 130. It will be appreciated that the configuration and engagement between the cylindrical rib 200, the connecting segment 202 and the cylindrical rib 200 provides a guided rotational movement between the connecting portion 134 and the base 130 about the center axis 140.

As will be described below, the connecting portion 134 can be selectively rotated relative to the base 130 and the anchor 132. As a result, a user can adjust a rotational position of the accessory 75.

Still referring to FIGS. 2 to 4 and 7, the fixing assembly 139 includes the fixing member 162, a lever 210 and a pin 212 (only partially shown in FIG. 2). In some embodiments, the fixing assembly 139 could be said to be part of the connecting portion 134.

The lever 210 is received in the side recess 160, and the pin 212 is received in the upper aperture 157. The lever 210 is pivotally connected to the base 130 via the pin 212. The lever 210 also has a cam 211 (FIG. 2) on its inner side. In more detail, the lever 210 is pivotable between an opened position and a closed position. In the opened position, the lever 210 at least partially extends out of the side recess 160, and the cam 211 is spaced from the fixing member 162. In the closed position, the lever 210 is at least mostly received in the side recess 160, and the cam 211 engages the fixing member 162. The engagement between the cam 211 and the fixing member 162 pushes the fixing member 162 toward the center axis 140. Additionally, when the lever 210 is moved into the closed position, the geometry of the cam 211 keeps the lever 210 in the closed position.

With the lever 210 in the open position, the cam 211 is not engaged to the fixing member 162, such that the connecting portion 134 is free to rotate about the center axis 140 relative to the base 130 and the anchor 132.

With the lever 210 in the closed position, the cam 211 pushes on the fixing member 162, which in turn pushes against the cylindrical rib 200. More specifically, the teeth of the cylindrical rib 200 engage the teeth of the fixing member 162. This engagement substantially rotationally fixes the connecting portion 134 relative to the base 130 (and thus relative to the anchor 132). However, if enough torque is applied on the connecting portion 134, the teeth of the fixing member 162 and the cylindrical rib 200 may slip on one another. This can assist in preventing the connector 104 or the accessory 75 from breaking due to an impact or from a user forgetting to move the lever 210 to the open position before turning the connecting portion 134 relative to the base 130.

Therefore, a rotational position of the accessory 75 relative to the mounting base 102 can be adjusted and then fixed with the fixing assembly 139.

Referring to FIGS. 2 to 12, the locking member 136, which is received in the locking recess 170, will now be described in greater detail. The locking member 136 includes a head 220 and a tail 222 that extends radially inwardly (i.e., toward the center axis 140) from a bottom of the head 220.

The head 220 has an engaging tab 230 extending radially outwardly therefrom (i.e., away from the center axis 140), such that the engaging tab 230 extends radially out of the locking recess 170. This enables a user to easily grasp the locking member 136.

The head 220 further has, on either lateral side thereof, interlockers 232 (FIGS. 2 and 3). The interlockers 232 are engaged to the interlockers 172 of the base 130. The engagement between the interlockers 232, 172 guides movement of the locking member 136 relative to the base 130. More specifically, the interlockers 232, 172 ensure that the locking member 136 translates between the locked and unlocked positions. Additionally, the interlockers 232, 172 are configured to stop movement of the locking member 136 relative to the base 130 once the locking member 136 reaches the locked position. It is understood that the configuration of the interlockers 232, 172 could vary from one embodiment to another. It is further contemplated that the locking member 136 could be caused to stop differently.

A radially inner side of the head 220 is arcuate, and is configured to provide clearance for the cylindrical rib 200.

The tail 222 defines a recess 234 on its upper surface. The recess 234 is sized to partially receive the biasing member 138 therein. The recess 234 prevents slippage of the biasing member 138 relative to the tail 222. It is contemplated that in other embodiments, the recess 234 could be omitted or replaced by a protrusion. The biasing member 138 is a metallic helical spring. It is contemplated that in other embodiments, the biasing member 138 could have another shape and/or be of another material. The biasing member 138 biases the locking member 136 toward the locked position.

The tail 222 has a locking tab 236. The locking tab 236 extends downwardly, generally parallel to the center axis 140. The locking tab 236 is sized and shaped to fit within the elongate aperture 114. In the present embodiment, the locking tab 236 has a generally rectangular shape, but it is contemplated that the overall shape thereof can vary.

It will be appreciated that due to the position of the locking recess 170, the locking tab 236 is angularly offset from the cams 180.

As mentioned above, the locking member 136 moves between the unlocked position and the locked position linearly. Thus, the locking member 136 translates between the unlocked and locked positions along a translation axis 137 (FIGS. 7 and 11). The locking member 136 translates toward the anchor 132 as the locking member 136 translates from the unlocked position to the locked position, and the locking member 136 translates away from the anchor 132 as the locking member 136 translates from the locked position to the unlocked position, such that in the direction defined by the translation axis 137, the locking member 136 is closer to the anchor 132 in the locked position than in the unlocked position. The translation axis 137 is generally parallel to the center axis 140. It is contemplated that in other embodiments, the locking member 136 could move differently.

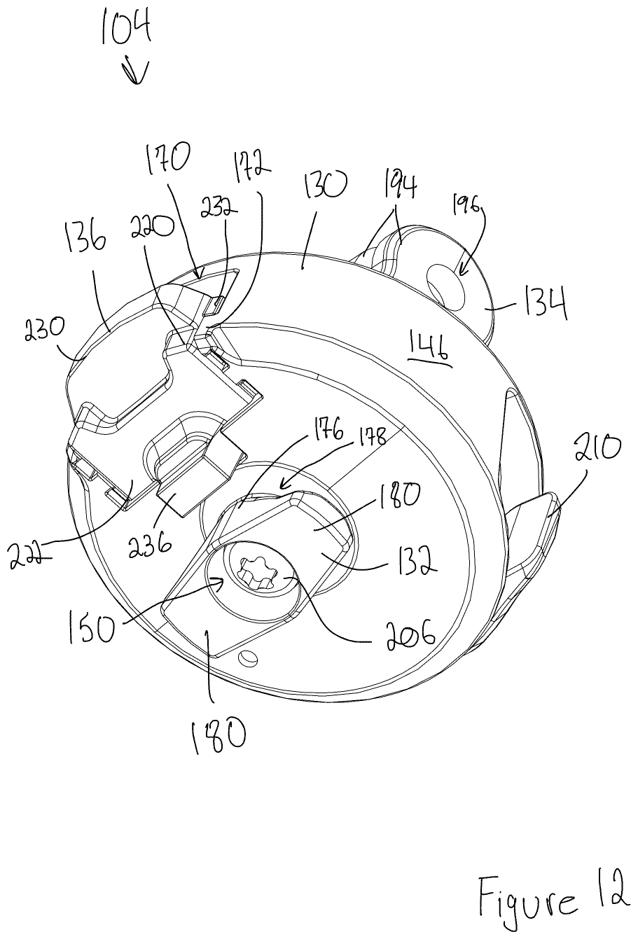

As best seen in FIGS. 7 and 12, when the locking member 136 is in the locked position, at least part of the locking tab 236 extends below the lower wall 144.

As best seen in FIG. 11, when the locking member 136 is in the unlocked position, the locking member 136 is mostly received in the locking recess 170, and the locking tab 236 does not extend below the lower wall 144.

Referring to FIG. 12, when the connector 104 is at rest and spaced from the mounting base 102, the locking member 136 is in the locked position due to the biasing member 138.

To connect the connector 104 to the mounting base 102, the connector 104 is placed above the mounting base 102, in a released position relative to the mounting base 102.

When the connector 104 is in the released position, the anchor 132 is aligned with the elongated aperture 114, such that as the connector 104 moves toward the mounting base 102, the anchor 132 can be received through the elongated aperture 114. Additionally, due to the angular offset between the cams 180 and the locking member 136, when the connector 104 is in the released position, the locking member 136 is misaligned with the elongated aperture 114. It will be appreciated that due to the shape and configuration of the anchor 132 and the elongated aperture 114, the connector 104 has two released positions relative to the mounting base 102 (the two released positions being 180 degrees from one another). It is contemplated that in other embodiments, depending on the shape of the anchor 132 and the elongated aperture 114, the connector 104 could have one or three or more released positions.

Thus, while in the released position, part of the connector 104 can be inserted into the mounting base 102. More specifically, the anchor 132 is received through the elongated aperture 114. As the anchor 132 is being received through the elongated aperture 114, the locking tab 236 of the locking member 136 abuts the upper side 110 of the mounting base 102, and begins to move, relative to the base 130, toward the upper wall 142 of the base 130 (i.e., the locking member 136 begins to move toward the unlocked position). When the anchor 132 is fully received in the elongated aperture 114, the locking member 136 is in the unlocked position.

Referring to FIGS. 4 to 7, the connector 104 is then moved to the anchored position. In the present embodiment, the connector 104 is moved from the released position to the anchored position by rotating the connector 104 relative to the mounting base 102 about the center axis 140 by a quarter-turn (about 90 degrees). It is contemplated that in other embodiments, the rotation of the connector 104 relative to the mounting base 102 about the center axis 140 to move from the released position to the anchored position, and vice-versa, could be more or less than 90 degrees. It will be appreciated that the base 130, the anchor 132, the connecting portion 134 and the locking member 136 all rotate together about the center axis 140. The connector 104 reaches the anchored position when the stoppers 122 engage the cams 180, thereby stopping rotation of the connector 104 relative to the mounting base 102.

In the anchored position, the anchor 132 is misaligned with the elongated aperture 114 such that the connector 104 cannot be translated out of the mounting base 102. Additionally, in the anchored position, the locking member 136 is aligned with one side of the elongated aperture 114. Thus, as the mounting base 102 no longer prevents the locking member 136 from reaching the locked position, the spring 138 pushes the locking member 136 to the locked position, where the locking tab 236 extends into the elongated aperture 114, thereby preventing rotation of the connector 104, and therefore preventing the connector 104 from being returned to the released position. Thus, in this case, a user may handle the accessory 75 or may adjust a rotational position of the connecting portion 134 relative to the base 130, without accidentally disconnecting the connector 104 from the mounting base 102.

To disconnect the connector 104 from the mounting base 102, the locking member 136 is first moved to the unlocked position. Handling of the locking member 136 is facilitated by the engaging tab 230. Once the locking tab 236 is in the unlocked position, the locking tab 236 is out of the elongated aperture 114, and the connector 104 is free to rotate relative to the mounting base 102 from the anchored position to the released position.

It will be appreciated that as the connector 104 is moved from the anchored position to the released position, the connecting portion 134, the base 130, the anchor 132, the connecting portion 134 and the locking member 136 all rotate together about the center axis 140. As soon as the locking member 236 is offset from the elongate aperture 114, the locking member 236 can be released, as the locking member 236 abuts a top of the mounting base 102.

When in the released position, the connector 104 can be moved away from the mounting base 102, such that the anchor 132 can be removed from the elongated aperture 114.

Modifications and improvements to the above-described embodiments of the present technology may become apparent to those skilled in the art. The foregoing description is intended to be exemplary rather than limiting.

What is claimed is:

1. A mounting assembly comprising:
a mounting base defining an aperture;
a connector selectively connected to the mounting base, the connector comprising:
a base, the base being larger than the aperture;
an anchor connected to the base, the anchor being configured to be received in the aperture;
a locking member movably connected to the base, the locking member being movable between an unlocked position and a locked position;
a biasing member abutting the locking member, the biasing member biasing the locking member toward the locked position;
the connector being movable relative to the mounting base between:
a released position, in which:
the anchor is aligned with the aperture such that the anchor is free to pass through the aperture; and
the locking member is misaligned with the aperture,
an anchored position, in which:
the anchor is received in and misaligned with the aperture such that the anchor is prevented from passing through the aperture;
the locking member is aligned with the aperture, and is movable between the unlocked position and the locked position;
in the unlocked position:
the locking member is removed from the aperture, and
the anchor is movable to the released position; and
in the locked position:
the locking member is at least partially received in the aperture, and
the locking member thereby prevents movement of the connector to the released position.

2. The mounting assembly of claim 1, wherein with the connector in the released position, and with the anchor received through the aperture, the locking member abuts the mounting base, the mounting base preventing the locking member from reaching the locked position.

3. The mounting assembly of claim 1, further comprising a connecting portion connected to the base, the connecting portion being configured to connect to an accessory.

4. The mounting assembly of claim 1, wherein the locking member translates between the unlocked position and the locked position.

5. The mounting assembly of claim 4, wherein the connector rotates about a rotation axis between the released position and the anchored position.

6. The mounting assembly of claim 5, further comprising a connecting portion connected to the base, the connecting portion being configured to connect to an accessory, the connecting portion being rotatable relative to the base about the rotation axis.

7. The mounting assembly of claim 5, wherein the locking member translates between the unlocked position and the locked position along a translation axis, the translation axis being substantially parallel to the rotation axis.

8. The mounting assembly of claim 1, wherein:
the aperture has a first elongate shape, and
the anchor has a second elongate shape, the second elongate shape being similar to the first elongate shape, the second elongate shape having smaller dimensions than the first elongate shape.

9. The mounting assembly of claim 1, wherein the base further comprises at least one stopper configured to stop movement of the connector once the anchored position is reached.

10. The mounting assembly of claim 1, wherein the locking member is radially and angularly offset from the anchor.

11. The mounting assembly of claim 1, wherein the biasing member is a spring disposed between the base and the locking member.

12. The mounting assembly of claim 1, wherein the locking member has an engaging tab extending beyond a lateral side of the base.

13. The mounting assembly of claim 1, wherein:
the base defines a locking recess, the recess having an at least partially open bottom;
the locking member is at least partially received in the locking recess, and
with the locking member in the locked position, at least part of the locking member extends out of the at least partially open bottom; and
with the locking member in the unlocked position, the locking member is at least mostly received in the recess, and a bottom of the locking member is disposed in the locking recess.

14. A connector comprising:
a base;
a stem connected to the base, the stem defining a rotation axis;
an anchor connected to the base via the stem;
a locking member movably connected to the base, the locking member translating between an unlocked position and a locked position along a translation axis, the translation axis being parallel to the rotation axis; and
a biasing member abutting the locking member, the biasing member biasing the locking member toward the locked position,
the base defining a first end of the connector,
the locking member defining a second end of the connector, the second end being opposite the first end,
the locking member translating away from the first end as the locking member translates from the unlocked position to the locked position, and
the locking member translating toward the first end as the locking member translates from the locked position to the unlocked position.

15. The connector of claim 14, further comprising a connecting portion connected to the base, the connecting portion being configured to connect to an accessory.

16. The connector of claim 15, wherein the connecting portion is rotatable relative to the base about the rotation axis.

17. The connector of claim 14, wherein the anchor has a first cam and a second cam extending opposite to the first cam, the first cam and the second cam defining an elongate shape.

18. The connector of claim 14, wherein the locking member is radially and angularly offset from the anchor.

19. The connector of claim 14, wherein the locking member has an engaging tab extending beyond a lateral side of the base.

20. The connector of claim 14, wherein:
the base defines a locking recess, the recess having an at least partially open bottom;
the locking member is at least partially received in the locking recess, and
with the locking member in the locked position, at least part of the locking member extends out of the at least partially open bottom; and
with the locking member in the unlocked position, the locking member is at least mostly received in the recess, and a bottom of the locking member is disposed in the locking recess.
